(19) United States
(12) Patent Application Publication
(10) Pub. No.: US 2024/0362730 A1
(43) Pub. Date: Oct. 31, 2024

(54) PROPERTY MAINTENANCE PLATFORM, CLIENT DEVICE AND METHODS FOR USE THEREWITH

(71) Applicant: HappyCo, Inc., Carlsbad, CA (US)

(72) Inventors: Ben Nowacky, Valley Center, CA (US); Bethany Lynn Haubert, Berkeley, CA (US); Jindou Lee, Carlsbad, CA (US)

(73) Assignee: HappyCo, Inc., Carlsbad, CA (US)

(21) Appl. No.: 18/338,639

(22) Filed: Jun. 21, 2023

Related U.S. Application Data
(60) Provisional application No. 63/499,078, filed on Apr. 28, 2023.

(51) Int. Cl. G06Q 50/16; G06Q 10/0631; G06Q 10/20

(52) U.S. Cl. CPC G06Q 50/163; G06Q 10/063114; G06Q 10/20

(57) ABSTRACT

A property management platform operates to: receive from a client device maintenance notification data that indicates a selected one of a plurality of maintenance issue categories and a selected one of a plurality of maintenance issue types that is specific to the selected one of the plurality of maintenance issue categories and a property identifier that indicates a specific property unit; automatically determine, based on the maintenance notification data, specific premises equipment at the specific property unit; generate maintenance self-help data, based on the maintenance notification data and the specific premises equipment at the specific property unit, wherein the maintenance self-help data includes self-help procedures specific to the specific premises equipment; send the maintenance self-help data to a user client device for display via a graphical user interface; receive from the client device, maintenance self-help results data indicating whether or not the selected one of the plurality of maintenance issue types has been resolved in response to the self-help procedures; and facilitate a maintenance request associated with the maintenance notification data and with the specific property unit, when the selected one of the plurality of maintenance issue types has not been resolved in response to the self-help procedures.

### CROSS-REFERENCE TO RELATED APPLICATIONS

The present U.S. Utility patent application claims priority pursuant to 35 U.S.C. § 119(e) to U.S. Provisional Application No. 63/499,078, entitled “PROPERTY MAINTENANCE PLATFORM, CLIENT DEVICE AND METHODS FOR USE THEREWITH”, filed Apr. 28, 2023, which is hereby incorporated herein by reference in its entirety and made part of the present U.S. Utility patent application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

The disclosed subject matter relates to computer systems and devices for managing and automating property maintenance operations.

### BRIEF DESCRIPTION OF THE SEVERAL VIEWS OF THE DRAWING(S)

FIG. 1 is a schematic block diagram of an automated property maintenance processing system.

FIGS. 2A through 2E are schematic block diagram of embodiments of computing entities that are part of an improved computer technology;

FIGS. 2F through 2L are schematic block diagram of embodiments of computing devices that form at least a portion of a computing entity;

FIG. 2M is a schematic block diagram of an embodiment of a database;

FIGS. 3A-3J present pictorial representation of portions of example screen displays of a client device.

FIGS. 3K-3V present pictorial representation of portions of example screen displays of a client device.

FIG. 4 presents a flowchart representation of an example method.

### DETAILED DESCRIPTION OF THE INVENTION

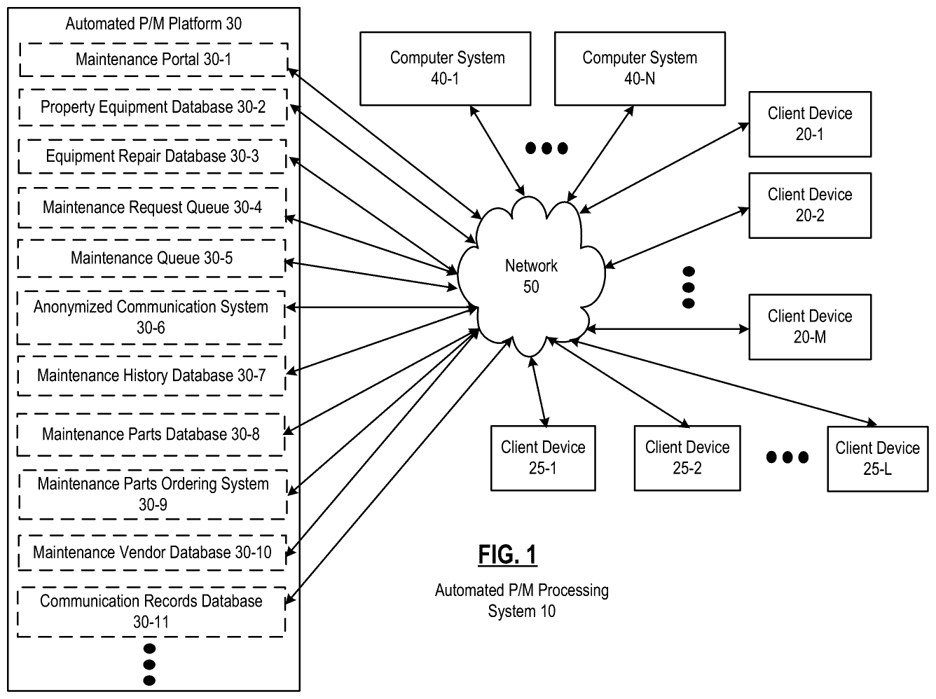

FIG. 1 is a schematic block diagram of an automated property maintenance (P/M) processing system 10 that communicates via network 50. The network 50 can include a wired and/or wireless network and can, for example, include the Internet or other wide area or local area network, either public or private.

The automated P/M processing system 10 includes a P/M platform 30 that communicates with M client devices 20 (such as client devices 20-1, 20-2, . . . 20-M) associated with users such as property owners, tenants and other short-term or long-term renters, residents, employees and/or other occupants of a property such as an office or other commercial building, a commercial or residential condo, a house and/or other single or multi-family dwelling, a campground, recreational vehicle park, marina and/or other property having one or more spaces and/or other property units under management. The P/M platform 30 also communicates with L client devices 25 (such as client devices 25-1, 25-2, . . . 25-L) associated with different maintenance personnel as well as N other computer systems 40 (such as computer systems 40-1, . . . 40-N) associated with property managers, equipment and/or other parts vendors, maintenance vendors and/or other entities associated with the maintenance and/or management of one or more properties.

The automated P/M platform 30 can include several different functions/features that, for the sake of simplicity, can be described as:
a maintenance portal 30-1 that, for example, allows maintenance personal and/or other administrators, to interact via their client device 25 with operations associated the processing and/or fulfillment of maintenance requests;
a property equipment database 30-2 that, for example, tracks the specific premises equipment (e.g., by make, model, serial number, QR code or other unique identifier) for each type or premises in place at each property unit of a plurality of property units to be serviced by the automated P/M platform 30;
an equipment repair database 30-3 that, for example, includes a knowledge-base, expert system and/or other artificial intelligence that stores text, images and/or videos presenting repair tutorials or other self-help procedures potential maintenance issues associated with each specific item of premises equipment of each specific type and furthermore, by each specific maintenance issue that could be associated therewith;
a maintenance request queue 30-4 that, for example, stores information associated with unfulfilled maintenance requests to be processed;
a maintenance queue 30-5 that, for example, stores information associated with maintenance requests being processed;
an anonymized communication system 30-6 that, for example, facilitates communication with client devices 20 in a fashion that is anonymized as to the particular client device 25 in use by particular maintenance personnel;
a maintenance history database 30-7 that, for example, maintains a record of past maintenance activities associated with each property unit of the plurality of property units to be serviced by the automated P/M platform 30;
a maintenance parts database 30-8 that, for example, maintains an inventory of the parts and/or premises equipment on-hand to service maintenance requests;
a maintenance parts ordering system 30-9 that, for example, facilitates procurement of the parts and/or premises equipment required to service maintenance requests;
a maintenance vendor database 30-10 that, for example, maintains records of the particular maintenance vendors for each distinct locale associated with the plurality of property units to be serviced by the automated P/M platform 30; and/or
a communication records database 30-11, the maintains a record of communications associated with the processing of maintenance requests.

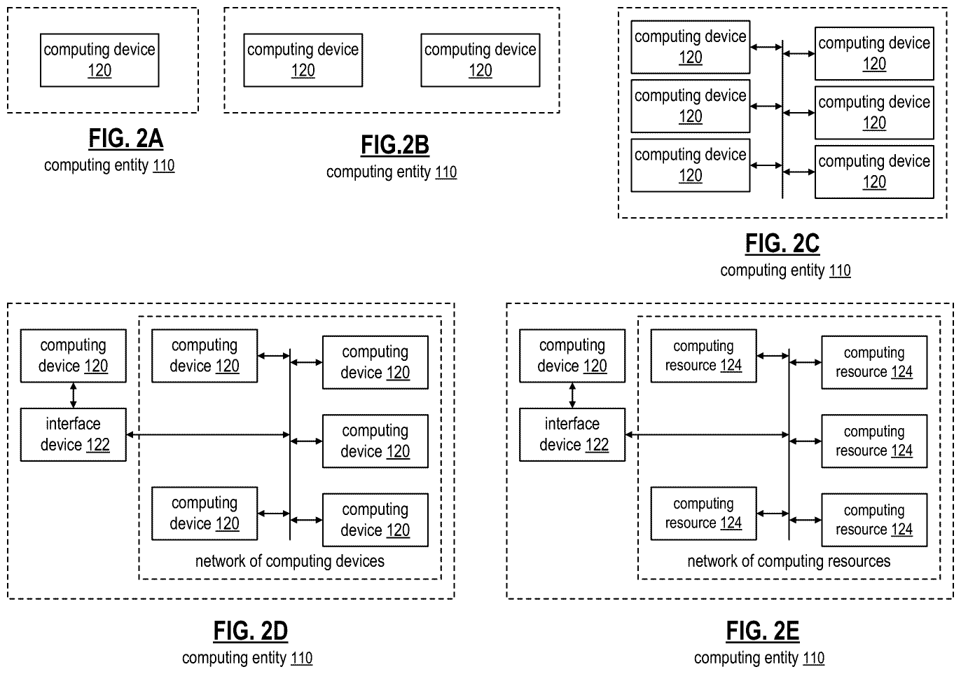

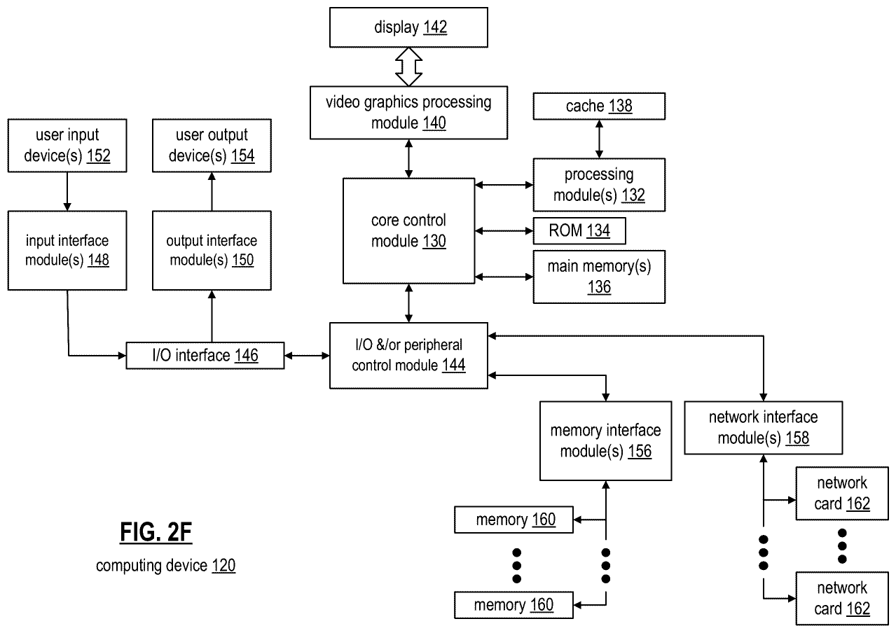

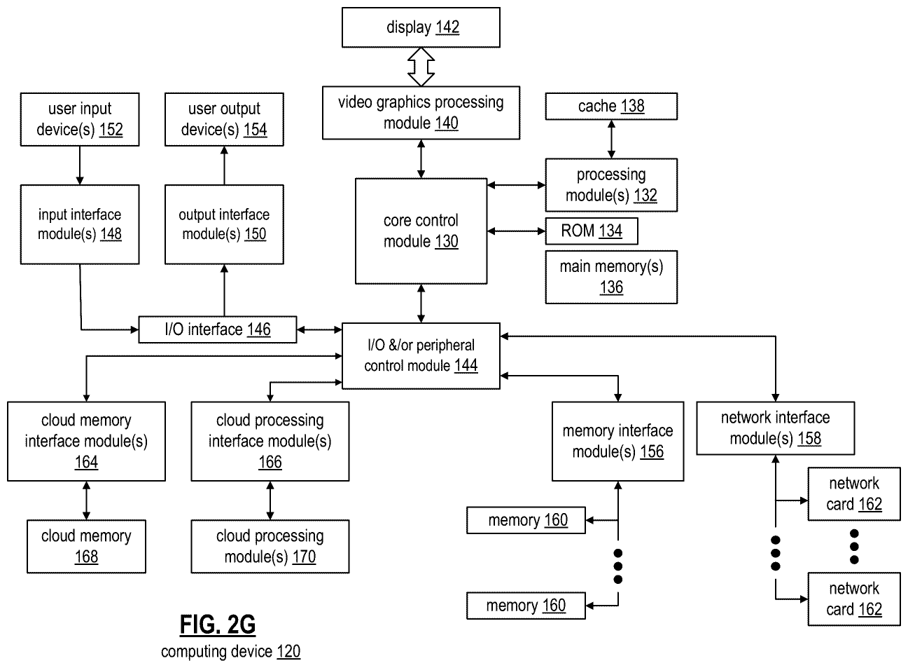

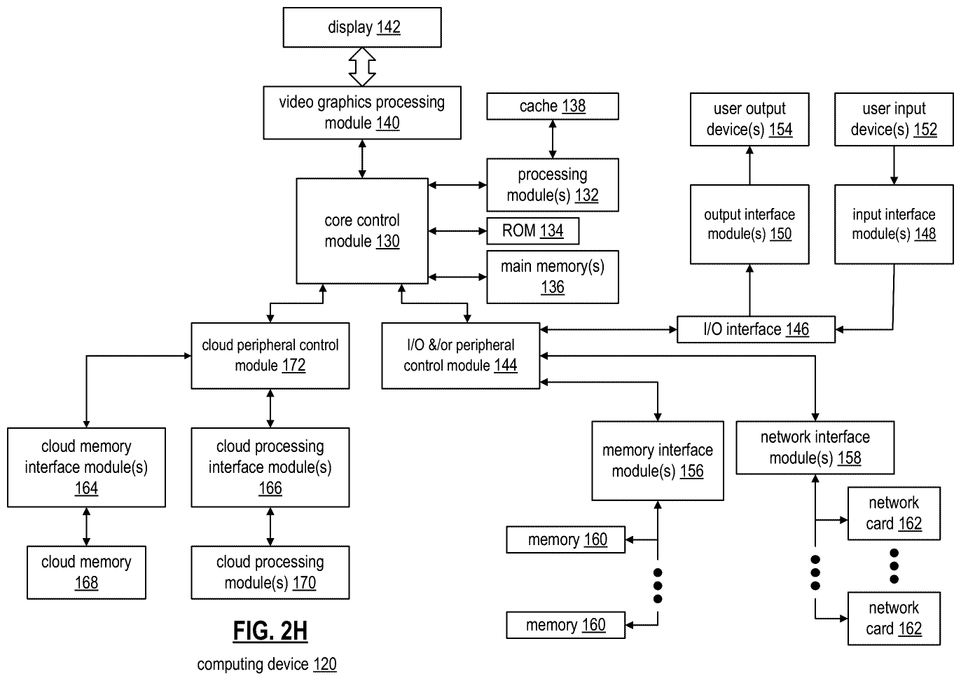

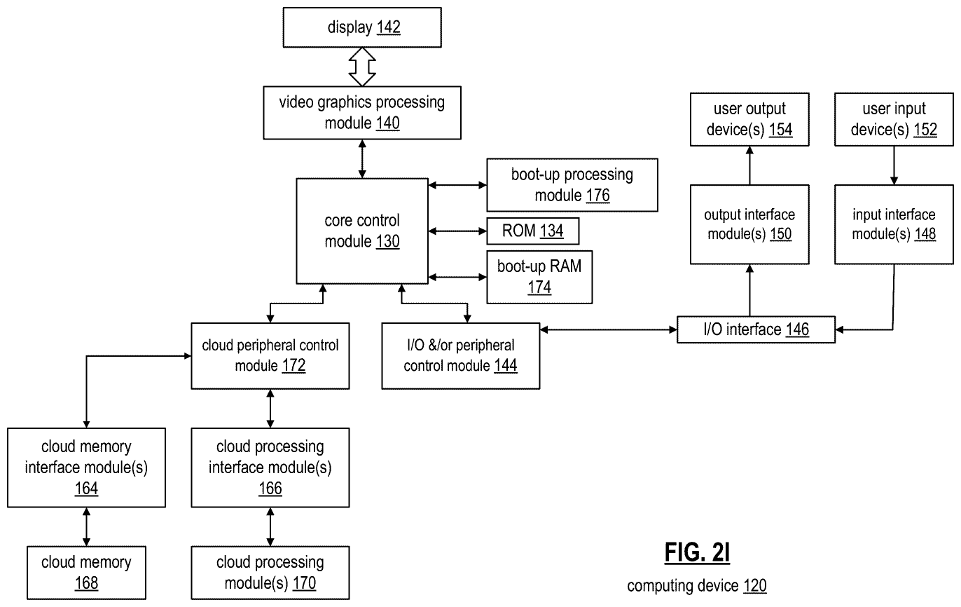

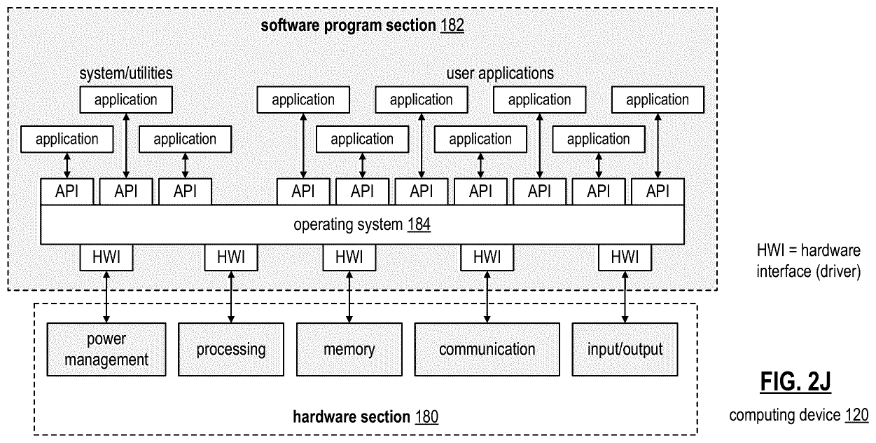

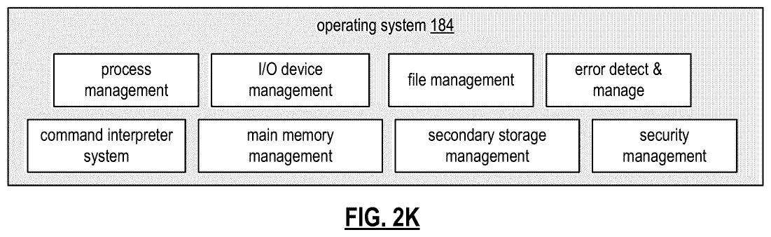

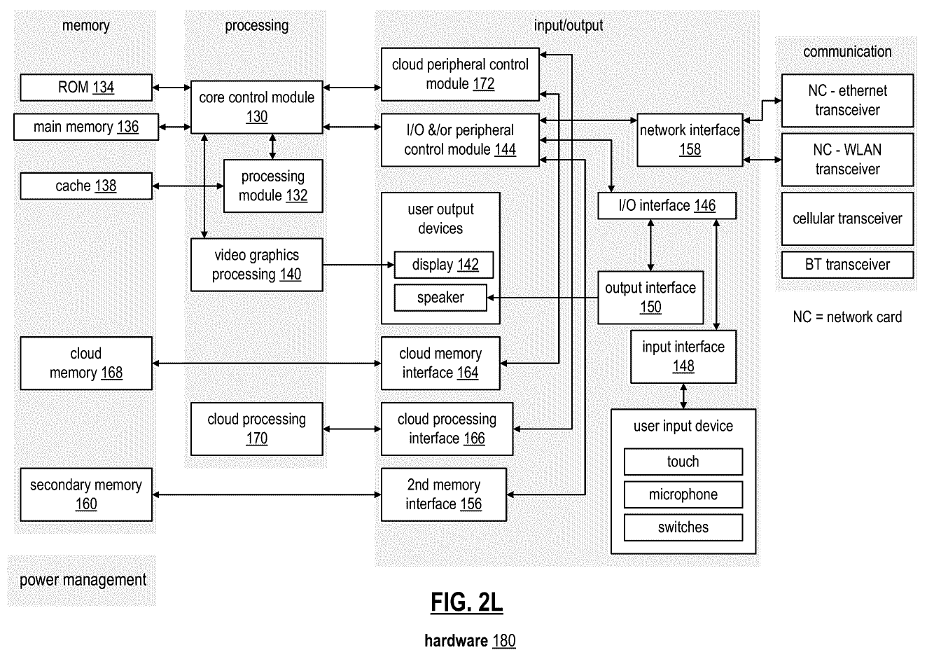

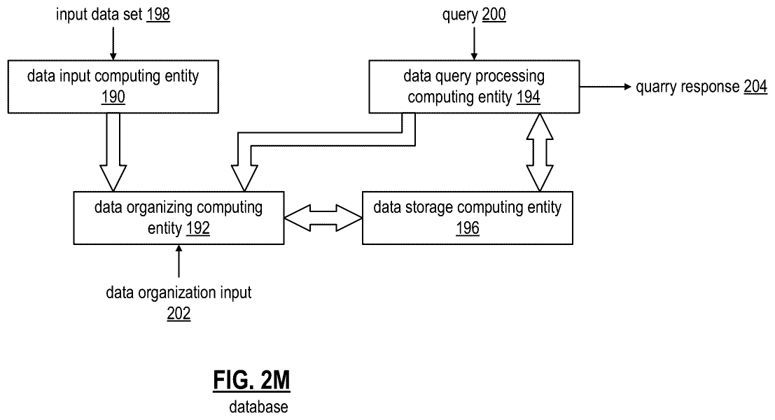

It should be noted that while the maintenance request queue 30-4 and the maintenance queue 30-5 are indicated as being separate, a single queue could be implemented to perform both functions by, for example, including an indication of whether or not the repair is in process. In various examples, the automated P/M platform 30 can include one or more other functions/features not specifically described above. Furthermore, in various examples, the client devices 20 and 25, the automated P/M platform 30 and the computer systems 40 can each be implemented via a computing entity 110 that will be described in greater detail in conjunction with FIGS. 2A-2M that follow. More specifically, the client devices 20 can each be implemented via a smartphone, tablet, laptop or other personal computing system associated with a property owner, tenant and other short-term or long-term renter, resident, employee and/or other occupant of a property. In addition or in the alternative, one or more of the client devices 20 can be implemented by tablet, laptop or other personal computing system that is dedicated to, installed within and/or otherwise associated with the property unit itself. In addition or in the alternative, the client devices 25 can each be implemented via a smartphone, tablet, laptop, desktop or other personal computing system for use by maintenance personnel, property managers, administrators of the automated P/M platform 30 and/or other users.

Consider the following example where the automated P/M platform 30 includes a network interface configured to engage in communications with user client devices and client devices associated with management personnel, at least one processor coupled to the network interface; and a memory that stores executable instructions that, when executed by the at least one processor, cause the client device to:
receive, via the network interface and generated via a graphical user interface of one of the user client devices, maintenance notification data that indicates a selected one of a plurality of maintenance issue categories and a selected one of a plurality of maintenance issue types that is specific to the selected one of the plurality of maintenance issue categories and a property identifier that indicates a specific property unit;
automatically determine, based on the maintenance notification data, specific premises equipment at the specific property unit;
generate maintenance self-help data, based on the maintenance notification data and the specific premises equipment at the specific property unit, wherein the maintenance self-help data includes self-help procedures specific to the specific premises equipment;
send the maintenance self-help data, via the network interface, to the one of the user client devices for display via the graphical user interface;
receive, via the one of the user client devices, maintenance self-help results data indicating whether or not the selected one of the plurality of maintenance issue types has been resolved in response to the self-help procedures; and
facilitate a maintenance request associated with the maintenance notification data and with the specific property unit, when the selected one of the plurality of maintenance issue types has not been resolved in response to the self-help procedures.

In addition or alternative to any of the foregoing, the memory further stores a property equipment database that correlates instances of premises equipment to each property unit of a plurality of property units, wherein the memory also stores an equipment repair database that correlates maintenance self-help data to the instances of premises equipment and also to corresponding ones of the plurality of maintenance issue types.

In addition or alternative to any of the foregoing, facilitating the maintenance request includes facilitating communications between maintenance personnel and a user of the client device regarding the maintenance request via an anonymized communication system utilizing one of the client devices associated with management personnel.

In addition or alternative to any of the foregoing, facilitating the maintenance request includes providing the maintenance personnel access to the maintenance request via a maintenance portal utilizing one of the client devices associated with management personnel.

In addition or alternative to any of the foregoing, the memory further stores a communication records database, and wherein facilitating the maintenance request includes storing the communications between maintenance personnel and the user of the client device regarding the maintenance request in the communication records database, and wherein the communications between maintenance personnel and the user of the client device regarding the maintenance request are accessible via the maintenance personnel utilizing the maintenance portal.

In addition or alternative to any of the foregoing, the communications between the maintenance personnel and the user of the client device regarding the maintenance request are accessible via the maintenance personnel utilizing the maintenance portal in conjunction with a subsequent maintenance request associated with the specific property unit.

In addition or alternative to any of the foregoing, facilitating the maintenance request includes queuing the maintenance request in a maintenance request queue that is accessible via the maintenance personnel utilizing the maintenance portal.

In addition or alternative to any of the foregoing, facilitating the maintenance request includes forwarding, in response to maintenance personnel interaction with the maintenance portal, the maintenance request, the communications between the maintenance personnel and the user of the client device regarding the maintenance request, and notes of the maintenance personnel, to at least one of: a maintenance vendor, property management personnel associated with the specific property unit, or other maintenance personnel that are in proximity to the specific property unit and shifting the maintenance from the maintenance request queue to a separate maintenance queue.

In addition or alternative to any of the foregoing, the memory further stores a maintenance history database, and wherein facilitating the maintenance request includes storing records regarding the maintenance request in the maintenance history database, and wherein the records regarding the maintenance request are accessible utilizing one of the client devices associated with management personnel via a maintenance portal.

In addition or alternative to any of the foregoing, the memory further stores a maintenance parts database, and wherein facilitating the maintenance request includes storing records regarding maintenance parts inventory in the maintenance parts database, and wherein the records regarding the maintenance parts inventory are accessible utilizing one of the client devices associated with management personnel via a maintenance portal.

In addition or alternative to any of the foregoing, the memory further stores a maintenance vendor database, and wherein facilitating the maintenance request includes storing records regarding maintenance vendors in the maintenance vendor database, and wherein the records regarding the maintenance vendors are accessible utilizing one of the client devices associated with management personnel via a maintenance portal.

In addition or alternative to any of the foregoing, facilitating the maintenance request includes providing maintenance personnel access to a maintenance parts ordering system utilizing one of the client devices associated with management personnel via a maintenance portal.

In addition or alternative to any of the foregoing, the maintenance notification data further indicates a selected one of a plurality of maintenance issue subcategories that is specific to the selected one of a plurality of maintenance issue categories, wherein the selected one of a plurality of a maintenance issue types is further specific to the selected one of the plurality of maintenance issue subcategories, wherein the graphical user interface presents a first menu that presents the plurality of maintenance issue categories, a second menu of the maintenance issue subcategories and a third menu of plurality of a maintenance issue types, and wherein the maintenance notification data is generated in response to interaction with the first menu, the second menu and the third menu via a user of the client device.

Consider the following example where a client device 20 includes a network interface configured to engage in communications with the property management platform, such as the automated P/M platform 30; a display device configured to implement a graphical user interface;

at least one processor coupled to the network interface and the display device; and a memory that stores executable instructions that, when executed by the at least one processor, cause the client device to:
generate, via the graphical user interface, maintenance notification data that indicates a selected one of a plurality of maintenance issue categories and a selected one of a plurality of maintenance issue types that is specific to the selected one of the plurality of maintenance issue categories;
send to the property management platform, via the network interface, the maintenance notification data and a property identifier that indicates a specific property unit;
receive from the property management platform, via the network interface, maintenance self-help data that includes self-help procedures generated based on the selected one of the plurality of maintenance issue categories and the selected one of the plurality of maintenance issue types, and is further based on automatic determination, via the property management platform, of specific premises equipment at the specific property unit and wherein the maintenance self-help data is specific to the specific premises equipment at the specific property unit;
display the maintenance self-help data via the graphical user interface to facilitate the self-help procedures;
receive, via the graphical user interface, maintenance self-help results data indicating whether or not the selected one of the plurality of maintenance issue types has been resolved in response to the self-help procedures; and
facilitate a maintenance request of the property management platform associated with the selected one of the plurality of maintenance issue types associated with the specific property unit, when the selected one of the plurality of maintenance issue types has not been resolved in response to the self-help procedures.

In addition or alternative to any of the foregoing, the property management platform includes a property equipment database that correlates instances of premises equipment to each property unit of a plurality of property units, wherein the property management platform further includes an equipment repair database that correlates maintenance self-help data to the instances of premises equipment and also to corresponding ones of the plurality of maintenance issue types.

In addition or alternative to any of the foregoing, the property management platform includes an anonymized communication system, and wherein facilitating the maintenance request includes facilitating communications between maintenance personnel and a user of the client device regarding the maintenance request via the anonymized communication system.

In addition or alternative to any of the foregoing, the property management platform includes a maintenance portal accessible by maintenance personnel, and wherein facilitating the maintenance request includes providing the maintenance personnel access to the maintenance request via the maintenance portal.

In addition or alternative to any of the foregoing, the property management platform includes a communication records database, and wherein facilitating the maintenance request includes storing the communications between maintenance personnel and the user of the client device regarding the maintenance request in the communication records database, and wherein the communications between maintenance personnel and the user of the client device regarding the maintenance request are accessible via the maintenance personnel utilizing the maintenance portal.

In addition or alternative to any of the foregoing, the communications between the maintenance personnel and the user of the client device regarding the maintenance request are accessible via the maintenance personnel utilizing the maintenance portal in conjunction with a subsequent maintenance request associated with the specific property unit.

In addition or alternative to any of the foregoing, facilitating the maintenance request includes queuing the maintenance request in a maintenance request queue that is accessible via the maintenance personnel utilizing the maintenance portal.

In addition or alternative to any of the foregoing, facilitating the maintenance request includes forwarding, in response to maintenance personnel interaction with the maintenance portal, the maintenance request, the communications between the maintenance personnel and the user of the client device regarding the maintenance request, and notes of the maintenance personnel, to at least one of: a maintenance vendor, property management personnel associated with the specific property unit, or other maintenance personnel that are in proximity to the specific property unit and shifting the maintenance from the maintenance request queue to a separate maintenance queue.

In addition or alternative to any of the foregoing, the property management platform includes a maintenance history database, and wherein facilitating the maintenance request includes storing records regarding the maintenance request in the maintenance history database, and wherein the records regarding the maintenance request are accessible via maintenance personnel utilizing a maintenance portal.

In addition or alternative to any of the foregoing, the property management platform includes a maintenance parts database, and wherein facilitating the maintenance request includes storing records regarding maintenance parts inventory in the maintenance parts database, and wherein the records regarding the maintenance parts inventory are accessible via maintenance personnel utilizing a maintenance portal.

In addition or alternative to any of the foregoing, the property management platform includes a maintenance vendor database, and wherein facilitating the maintenance request includes storing records regarding maintenance vendors in the maintenance vendor database, and wherein the records regarding the maintenance vendors are accessible via maintenance personnel utilizing a maintenance portal.

In addition or alternative to any of the foregoing, the property management platform includes a maintenance parts ordering system, and wherein facilitating the maintenance request includes providing access to the maintenance parts ordering system to maintenance personnel utilizing a maintenance portal.

In addition or alternative to any of the foregoing, the maintenance notification data further indicates a selected one of a plurality of maintenance issue subcategories that is specific to the selected one of a plurality of maintenance issue categories, wherein the selected one of a plurality of a maintenance issue types is further specific to the selected one of the plurality of maintenance issue subcategories, wherein the graphical user interface presents a first menu that presents the plurality of maintenance issue categories, a second menu of the maintenance issue subcategories and a third menu of plurality of a maintenance issue types, and wherein the maintenance notification data is generated in response to interaction with the first menu, the second menu and the third menu via a user of the client device.

The automated P/M system 10 improves the technology of property management systems by maintaining a property equipment database 30-2 that indicates the specific premises equipment that is present at each property unit and by facilitating, in an automated fashion, the provision of self-help procedures from an equipment repair database 30-3 that are tailored not only to the specifics of a maintenance issue for a particular property unit, but also tailored to the specific premises equipment at the particular property unit. In this fashion, many potential maintenance issues can be resolved without need of intervention by maintenance personnel.

The automated P/M system 10 also improves the technology of property management systems by providing a maintenance portal 30-1 that tracks incoming requests in a maintenance request queue 30-4 and that facilitates remote communication between maintenance personnel and property unit occupants. These communications can be anonymized an anonymized communication system 30-6 that for example, anonymizes the caller ID/email address or other identifiers of the maintenance personnel so that such communications cannot continue directly by maintenance personnel. Maintenance personnel can access prior maintenance of that particular property unit via a maintenance history database 30-7, prior communications with other maintenance personnel regarding the issue that are stored in a communication records database 30-11, the self-help procedures, the property equipment database—so again, many maintenance issues can be resolved without the need of a service visit.

The automated P/M system 10 also improves the technology of property management systems by providing a maintenance portal 30-1 that can be used to properly route a maintenance request that requires an onsite visit, for example, to onsite personnel, a property manager or a maintenance vendor identified via a maintenance vendor database 30-10. Notes prepared by maintenance personnel via the maintenance portal 30-1 can be forwarded along with these referrals along with information on inventory gathered via a maintenance parts database 30-8 to help facilitate a maintenance visit and ensure that the repair personnel have the proper insights as to the issue, the steps that have been previously taken, the premises equipment on site, and/or the available parts that may be necessary to the visit. These referrals and further processing of these maintenance issues can be tracked to completion via a maintenance queue 30-5 that is also accessible via the maintenance portal 30-1. In the event that the inventory is low or there is no available inventory, a maintenance parts order system 30-9 is accessible by the maintenance portal 30-1 to restock.

As noted above, the property equipment database 30-2, for example, tracks the specific premises equipment (e.g., by make, model, serial number, QR code or other unique identifier) for each type or premises in place at each property unit of a plurality of property units to be serviced by the automated P/M platform 30. Furthermore, the equipment repair database 30-3, for example, includes a knowledge-base, expert system and/or other artificial intelligence that stores text, images, videos and/or other media presenting repair tutorials or other self-help procedures potential maintenance issues associated with each specific item of premises equipment of each specific type and furthermore, by each specific maintenance issue that could be associated therewith. These two databases alone encompass data storage, indexing and retrieval on such a massive scale (gigabytes, terabytes or more) that it would be impractical to implement within the human mind. Also, in various examples, the processing implemented by the equipment repair database 30-3 to retrieve the relevant self-help procedures for each particular maintenance issue over a wide range of products and disciplines that require artificial, i.e. “non-human” intelligence that could not be implemented within the human mind. In addition, in various examples, the automated P/M platform 30 utilizes parallel processing to simultaneously/contemporaneously serve multiple client devices 20 and multiple clients 25—again a process that could not practically be performed within the human mind.

Further details regarding the operation of the automated property maintenance processing system, including several optional implementations, functions and features are described in conjunction with the Figures that follow.

FIGS. 2A through 2E are schematic block diagram of embodiments of computing entities that form at least part of an improved computer technology. In particular, these computing entities can be used to implement the property maintenance platform 30, the client devices 20 and/or 25, and/or the property systems 40.

FIG. 2A is schematic block diagram of an embodiment of a computing entity 110 that includes a computing device 120 (e.g., one or more of the embodiments of FIGS. 2F-2L). A computing device may function as a user computing device, a server, a system computing device, a data storage device, a data security device, a networking device, a user access device, a cell phone, a tablet, a laptop, a printer, a game console, a satellite control box, a cable box, etc.

FIG. 2B is schematic block diagram of an embodiment of a computing entity 110 that includes two or more computing devices 120 (e.g., two or more from any combination of the embodiments of FIGS. 2F-2L). The computing devices 120 perform the functions of a computing entity in a peer processing manner (e.g., coordinate together to perform the functions), in a master-slave manner (e.g., one computing device coordinates and the other support it), and/or in another manner.

FIG. 2C is schematic block diagram of an embodiment of a computing entity 110 that includes a network of computing devices 120 (e.g., two or more from any combination of the embodiments of FIGS. 2F-2L). The computing devices are coupled together via one or more network connections (e.g., WAN, LAN, cellular data, WLAN, etc.) and preform the functions of the computing entity.

FIG. 2D is schematic block diagram of an embodiment of a computing entity 110 that includes a primary computing device (e.g., any one of the computing devices of FIGS. 2F-2L), an interface device (e.g., a network connection), and a network of computing devices 120 (e.g., one or more from any combination of the embodiments of FIGS. 2F-2L). The primary computing device utilizes the other computing devices as co-processors to execute one or more the functions of the computing entity, as storage for data, for other data processing functions, and/or storage purposes.

FIG. 2E is schematic block diagram of an embodiment of a computing entity 110 that includes a primary computing device (e.g., any one of the computing devices of FIGS. 2F-2L), an interface device (e.g., a network connection) 122, and a network of computing resources 124 (e.g., two or more resources from any combination of the embodiments of FIGS. 2F-2L). The primary computing device utilizes the computing resources as co-processors to execute one or more the functions of the computing entity, as storage for data, for other data processing functions, and/or storage purposes.

FIGS. 2F-2L are schematic block diagram of embodiments of computing devices that form at least a portion of a computing entity. FIG. 2F is a schematic block diagram of an embodiment of a computing device 120 that includes a plurality of computing resources. The computing resources, which form a computing core, include one or more core control modules 130, one or more processing modules 132, one or more main memories 136, a read only memory (ROM) 134 for a boot up sequence, cache memory 138, one or more video graphics processing modules 140, one or more displays 142 (optional), an Input-Output (I/O) peripheral control module 144, an I/O interface module 146 (which could be omitted if direct connect IO is implemented), one or more input interface modules 148, one or more output interface modules 150, one or more network interface modules 158, and one or more memory interface modules 156.

A processing module 132 is described in greater detail at the end of the detailed description section and, in an alternative embodiment, has a direction connection to the main memory 136. In an alternate embodiment, the core control module 130 and the I/O and/or peripheral control module 144 are one module, such as a chipset, a quick path interconnect (QPI), and/or an ultra-path interconnect (UPI).

The processing module 132, the core module 130, and/or the video graphics processing module 140 form a processing core for the improved computer. Additional combinations of processing modules 132, core modules 130, and/or video graphics processing modules 140 form co-processors for the improved computer for technology. Computing resources 124 of FIG. 2E include one more of the components shown in this Figure and/or in or more of FIGS. 2G through 2L.

Each of the main memories 136 includes one or more Random Access Memory (RAM) integrated circuits, or chips. In general, the main memory 136 stores data and operational instructions most relevant for the processing module 132. For example, the core control module 130 coordinates the transfer of data and/or operational instructions between the main memory 136 and the secondary memory device(s) 160. The data and/or operational instructions retrieve from secondary memory 160 are the data and/or operational instructions requested by the processing module or will most likely be needed by the processing module. When the processing module is done with the data and/or operational instructions in main memory, the core control module 130 coordinates sending updated data to the secondary memory 160 for storage.

The secondary memory 160 includes one or more hard drives, one or more solid state memory chips, and/or one or more other large capacity storage devices that, in comparison to cache memory and main memory devices, is/are relatively inexpensive with respect to cost per amount of data stored. The secondary memory 160 is coupled to the core control module 130 via the I/O and/or peripheral control module 144 and via one or more memory interface modules 156. In an embodiment, the I/O and/or peripheral control module 144 includes one or more Peripheral Component Interface (PCI) buses to which peripheral components connect to the core control module 130. A memory interface module 156 includes a software driver and a hardware connector for coupling a memory device to the I/O and/or peripheral control module 144. For example, a memory interface 156 is in accordance with a Serial Advanced Technology Attachment (SATA) port.

The core control module 130 coordinates data communications between the processing module(s) 132 and network(s) via the I/O and/or peripheral control module 144, the network interface module(s) 158, and one or more network cards 162. A network card 160 includes a wireless communication unit or a wired communication unit. A wireless communication unit includes a wireless local area network (WLAN) communication device, a cellular communication device, a Bluetooth device, and/or a ZigBee communication device. A wired communication unit includes a Gigabit LAN connection, a Firewire connection, and/or a proprietary computer wired connection. A network interface module 158 includes a software driver and a hardware connector for coupling the network card to the I/O and/or peripheral control module 144. For example, the network interface module 158 is in accordance with one or more versions of IEEE 802.11, cellular telephone protocols, 10/100/1000 Gigabit LAN protocols, etc.

The core control module 130 coordinates data communications between the processing module(s) 132 and input device(s) 152 via the input interface module(s) 148, the I/O interface 146, and the I/O and/or peripheral control module 144. An input device 152 includes a keypad, a keyboard, control switches, a touchpad, a microphone, a camera, etc. An input interface module 148 includes a software driver and a hardware connector for coupling an input device to the I/O and/or peripheral control module 144. In an embodiment, an input interface module 148 is in accordance with one or more Universal Serial Bus (USB) protocols.

The core control module 130 coordinates data communications between the processing module(s) 132 and output device(s) 154 via the output interface module(s) 150 and the I/O and/or peripheral control module 144. An output device 154 includes a speaker, auxiliary memory, headphones, etc. An output interface module 150 includes a software driver and a hardware connector for coupling an output device to the I/O and/or peripheral control module 144. In an embodiment, an output interface module 150 is in accordance with one or more audio codec protocols.

The processing module 132 communicates directly with a video graphics processing module 140 to display data on the display 142. The display 142 includes an LED (light emitting diode) display, an LCD (liquid crystal display), and/or other type of display technology. The display has a resolution, an aspect ratio, and other features that affect the quality of the display. The video graphics processing module 140 receives data from the processing module 132, processes the data to produce rendered data in accordance with the characteristics of the display, and provides the rendered data to the display 142.

FIG. 2G is a schematic block diagram of an embodiment of a computing device 120 that includes a plurality of computing resources similar to the computing resources of FIG. 2F with the addition of one or more cloud memory interface modules 164, one or more cloud processing interface modules 166, cloud memory 168, and one or more cloud processing modules 170. The cloud memory 168 includes one or more tiers of memory (e.g., ROM, volatile (RAM, main, etc.), non-volatile (hard drive, solid-state, etc.) and/or backup (hard drive, tape, etc.)) that is remoted from the core control module and is accessed via a network (WAN and/or LAN). The cloud processing module 170 is similar to processing module 132 but is remote from the core control module and is accessed via a network.

FIG. 2H is a schematic block diagram of an embodiment of a computing device 120 that includes a plurality of computing resources similar to the computing resources of FIG. 2G with a change in how the cloud memory interface module(s) 164 and the cloud processing interface module(s) 166 are coupled to the core control module 130. In this embodiment, the interface modules 164 and 166 are coupled to a cloud peripheral control module 172 that directly couples to the core control module 130.

FIG. 2I is a schematic block diagram of an embodiment of a computing device 120 that includes a plurality of computing resources, which includes include a core control module 130, a boot up processing module 176, boot up RAM 174, a read only memory (ROM) 134, a one or more video graphics processing modules 140, one or more displays 48 (optional), an Input-Output (I/O) peripheral control module 144, one or more input interface modules 148, one or more output interface modules 150, one or more cloud memory interface modules 164, one or more cloud processing interface modules 166, cloud memory 168, and cloud processing module(s) 170.

In this embodiment, the computing device 120 includes enough processing resources (e.g., module 176, ROM 134, and RAM 174) to boot up. Once booted up, the cloud memory 168 and the cloud processing module(s) 170 function as the computing device's memory (e.g., main and hard drive) and processing module.

FIG. 2J is a schematic block diagram of another embodiment of a computing device 120 that includes a hardware section 180 and a software program section 182. The hardware section 180 includes the hardware functions of power management, processing, memory, communications, and input/output. FIG. 2L illustrates the hardware section 180 in greater detail.

The software program section 182 includes an operating system 184, system and/or utilities applications, and user applications. The software program section further includes APIs and HWIs. APIs (application programming interface) are the interfaces between the system and/or utilities applications and the operating system and the interfaces between the user applications and the operating system 184. HWIs (hardware interface) are the interfaces between the hardware components and the operating system. For some hardware components, the HWI is a software driver. The functions of the operating system 184 are discussed in greater detail with reference to FIG. 2K.

FIG. 2K is a diagram of an example of the functions of the operating system of a computing device 120. In general, the operating system function to identify and route input data to the right places within the computer and to identify and route output data to the right places within the computer. Input data is with respect to the processing module and includes data received from the input devices, data retrieved from main memory, data retrieved from secondary memory, and/or data received via a network card. Output data is with respect to the processing module and includes data to be written into main memory, data to be written into secondary memory, data to be displayed via the display and/or an output device, and data to be communicated via a network care.

The operating system 184 includes the OS functions of process management, command interpreter system, I/O device management, main memory management, file management, secondary storage management, error detection & correction management, and security management. The process management OS function manages processes of the software section operating on the hardware section, where a process is a program or portion thereof.

The process management OS function includes a plurality of specific functions to manage the interaction of software and hardware. The specific functions include:
load a process for execution;
enable at least partial execution of a process;
suspend execution of a process;
resume execution of a process;
terminate execution of a process;
load operational instructions and/or data into main memory for a process;
provide communication between two or more active processes;
avoid deadlock of a process and/or interdependent processes; and
control access to shared hardware components.

The I/O Device Management OS function coordinates translation of input data into programming language data and/or into machine language data used by the hardware components and translation of machine language data and/or programming language data into output data. Typically, input devices and/or output devices have an associated driver that provides at least a portion of the data translation. For example, a microphone captures analog audible signals and converts them into digital audio signals per an audio encoding format. An audio input driver converts, if needed, the digital audio signals into a format that is readily usable by a hardware component.

The File Management OS function coordinates the storage and retrieval of data as files in a file directory system, which is stored in memory of the computing device. In general, the file management OS function includes the specific functions of:
File creation, editing, deletion, and/or archiving;
Directory creation, editing, deletion, and/or archiving;
Memory mapping files and/or directors to memory locations of secondary memory; and
Backing up of files and/or directories.

The Network Management OS function manages access to a network by the computing device. Network management includes
Network fault analysis;
Network maintenance for quality of service;
Network access control among multiple clients; and
Network security upkeep.

The Main Memory Management OS function manages access to the main memory of a computing device. This includes keeping track of memory space usage and which processes are using it; allocating available memory space to requesting processes; and deallocating memory space from terminated processes.

The Secondary Storage Management OS function manages access to the secondary memory of a computing device. This includes free memory space management, storage allocation, disk scheduling, and memory defragmentation.

The Security Management OS function protects the computing device from internal and external issues that could adversely affect the operations of the computing device. With respect to internal issues, the OS function ensures that processes negligibly interfere with each other; ensures that processes are accessing the appropriate hardware components, the appropriate files, etc.; and ensures that processes execute within appropriate memory spaces (e.g., user memory space for user applications, system memory space for system applications, etc.).

The security management OS function also protects the computing device from external issues, such as, but not limited to, hack attempts, phishing attacks, denial of service attacks, bait and switch attacks, cookie theft, a virus, a trojan horse, a worm, click jacking attacks, keylogger attacks, eavesdropping, waterhole attacks, SQL injection attacks, and DNS spoofing attacks.

FIG. 2L is a schematic block diagram of the hardware components of the hardware section 180 of a computing device. The memory portion of the hardware section includes the ROM 134, the main memory 136, the cache memory 138, the cloud memory 168, and the secondary memory 160. The processing portion of the hardware section includes the core control module 130, the processing module 132, the video graphics processing module 140, and the cloud processing module 170.

The input/output portion of the hardware section includes the cloud peripheral control module 172, the I/O and/or peripheral control module 144, the network interface module 158, the I/O interface module 146, the output device interface 150, the input device interface 148, the cloud memory interface module 164, the cloud processing interface module 166, and the secondary memory interface module 156. The IO portion further includes input devices such as a touch screen, a microphone, and switches. The IO portion also includes output devices such as speakers and a display.

The communication portion includes an ethernet transceiver network card (NC), a WLAN network card, a cellular transceiver, a Bluetooth transceiver, and/or any other device for wired and/or wireless network communication.

FIG. 2M is a schematic block diagram of an embodiment of a database that includes a data input computing entity 190, a data organizing computing entity 192, a data query processing computing entity 194, and a data storage computing entity 196. Each of the computing entities is an implementation in accordance with one or more of the embodiments of FIGS. 2A through 2E.

The data input computing entity 190 is operable to receive an input data set 198. The input data set 198 is a collection of related data that can be represented in a tabular form of columns and rows, and/or other tabular structure. In an example, the columns represent different data elements of data for a particular source and the rows corresponds to the different sources (e.g., employees, licenses, email communications, etc.).

If the data set 198 is in a desired tabular format, the data input computing entity 190 provides the data set to the data organizing computing entity 192. If not, the data input computing entity 190 reformats the data set to put it into the desired tabular format.

The data organizing computing entity 192 organizes the data set 198 in accordance with a data organizing input 202. In an example, the input 202 is regarding a particular query and requests that the data be organized for efficient analysis of the data for the query. In another example, the input 202 instructions the data organizing computing entity 192 to organize the data in a time-based manner. The organized data is provided to the data storage computing entity for storage.

When the data query processing computing entity 194 receives a query 200, it accesses the data storage computing entity 196 regarding a data set for the query. If the data set is stored in a desired format for the query, the data query processing computing entity 194 retrieves the data set and executes the query to produce a query response 204. If the data set is not stored in the desired format, the data query processing computing entity 194 communicates with the data organizing computing entity 192, which re-organizes the data set into the desired format.

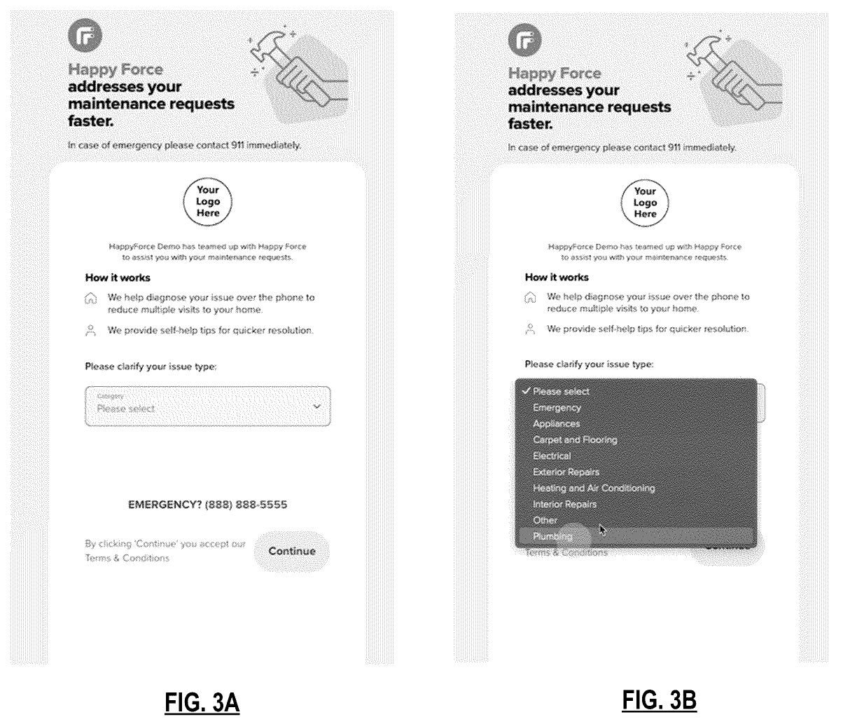

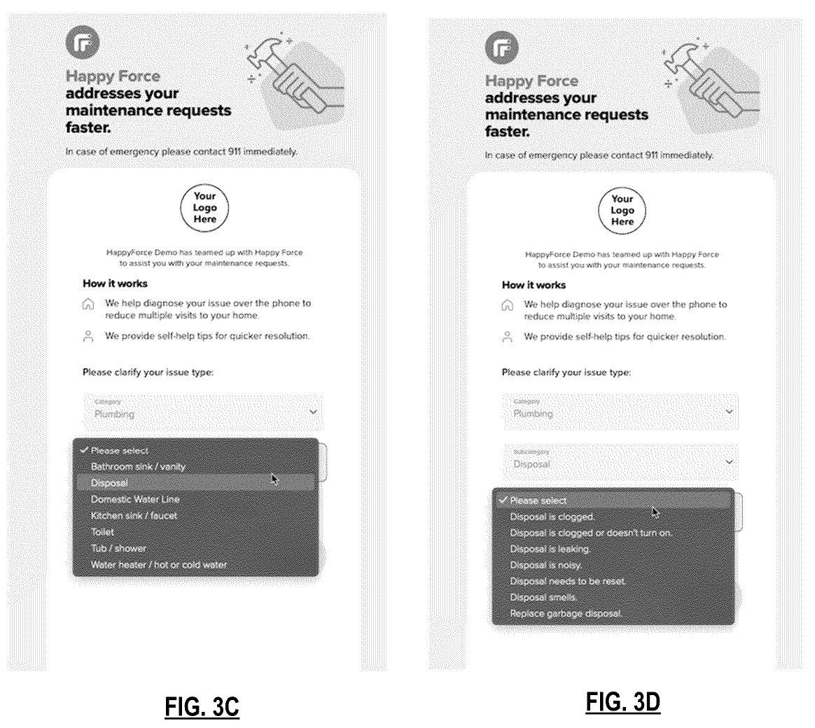

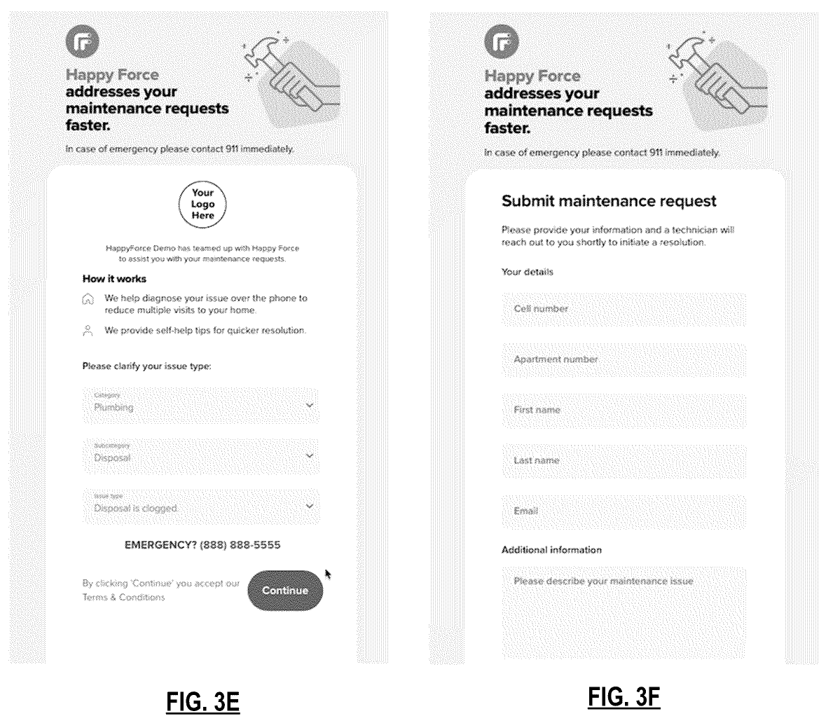

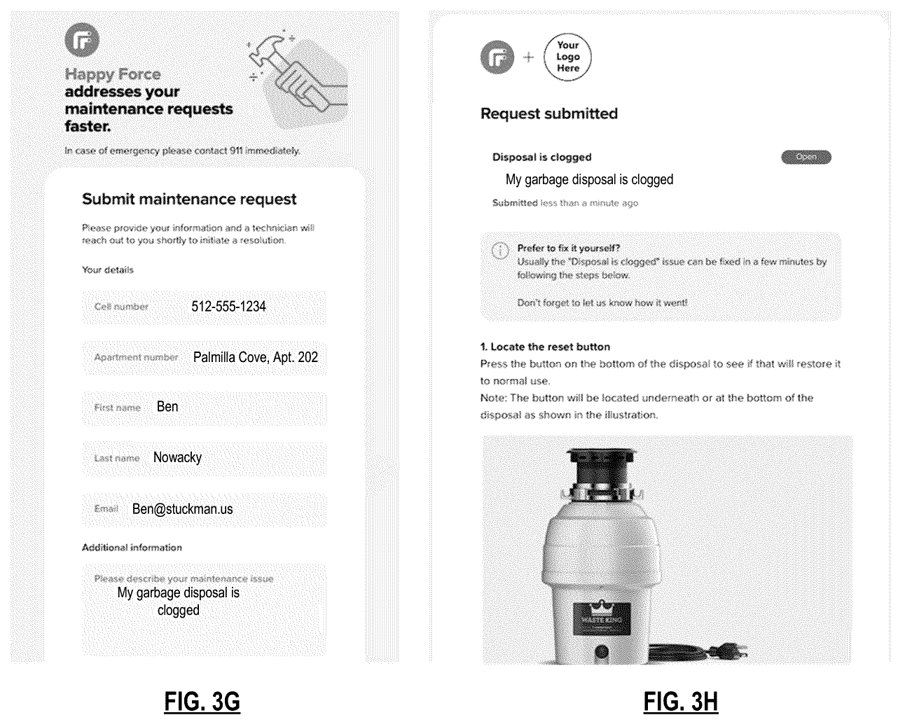

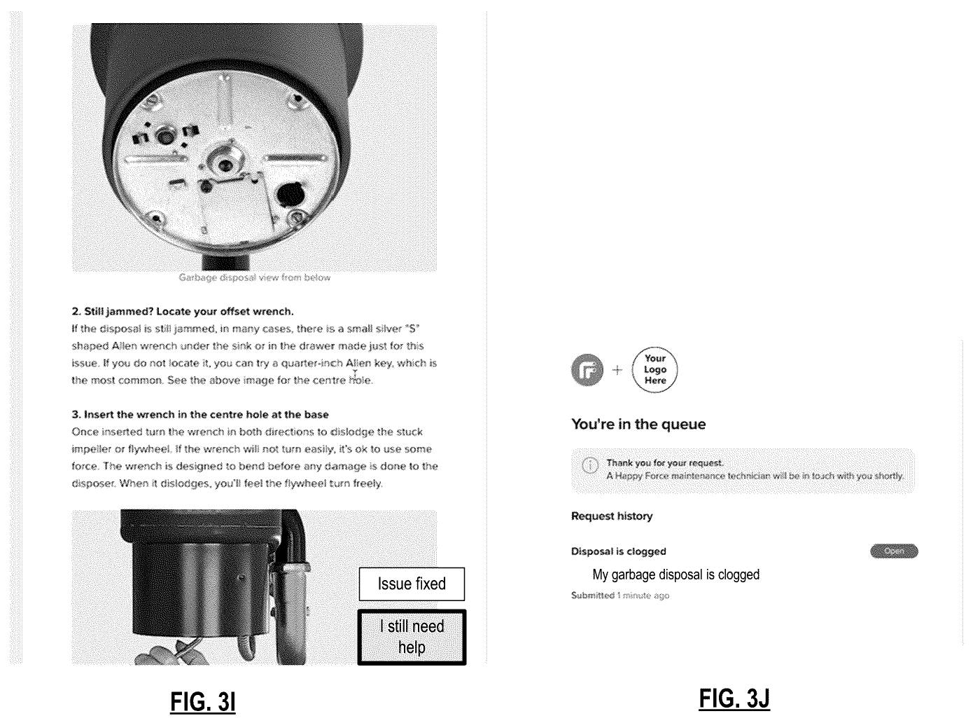

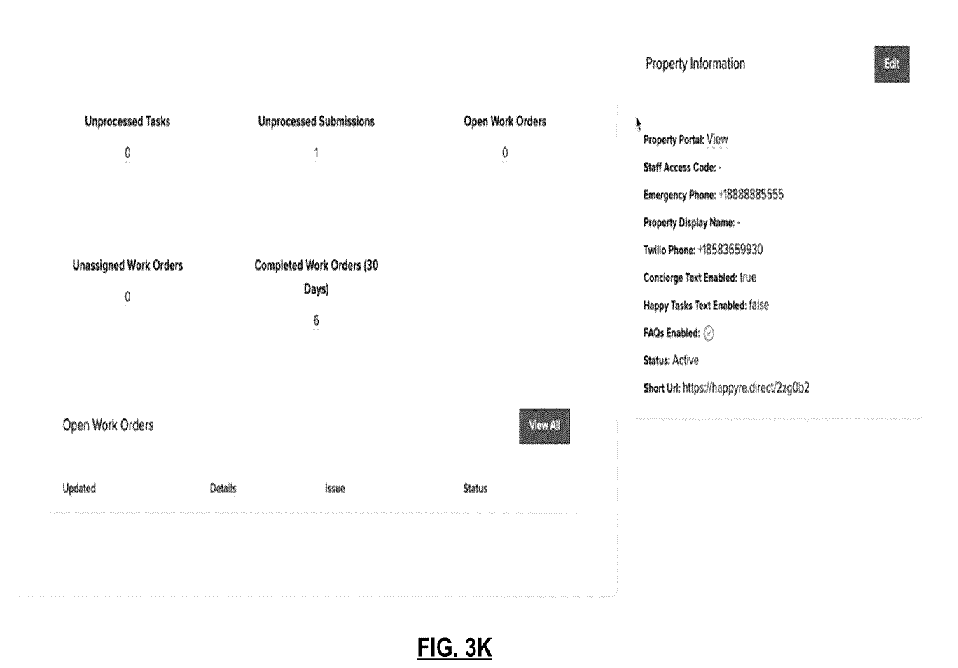

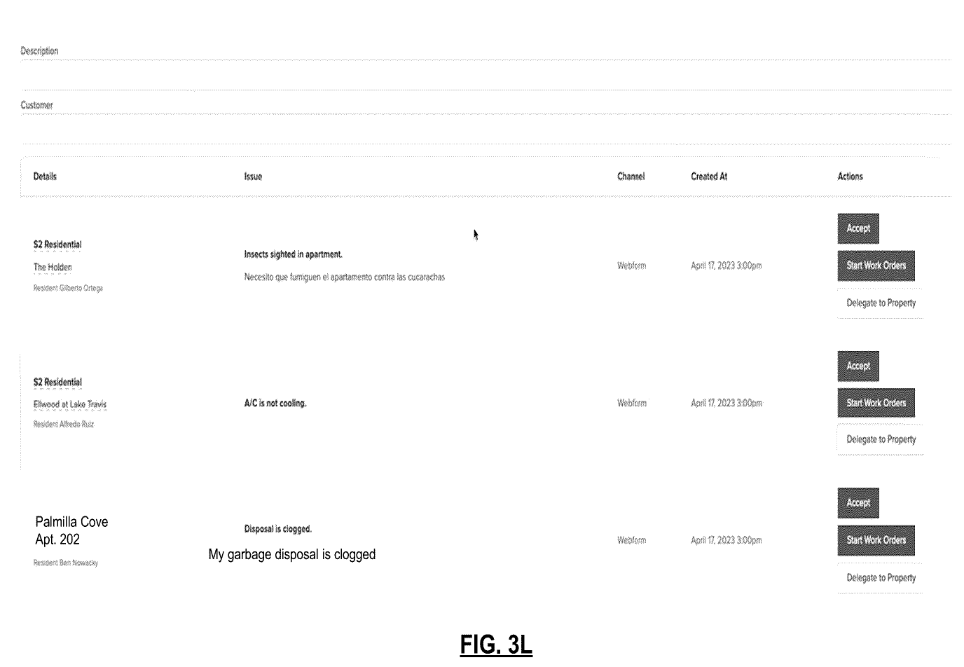

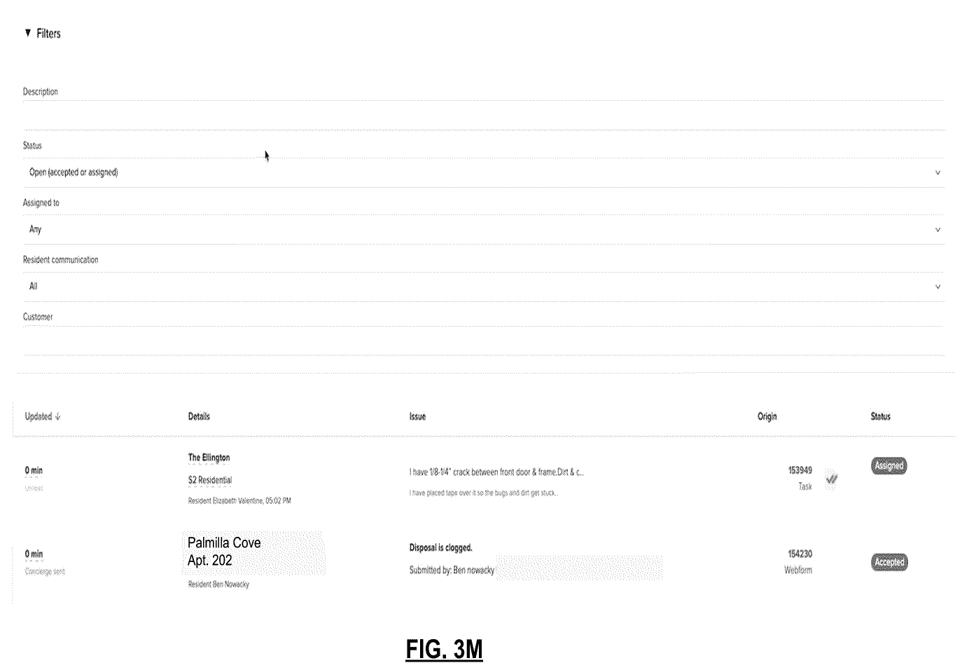

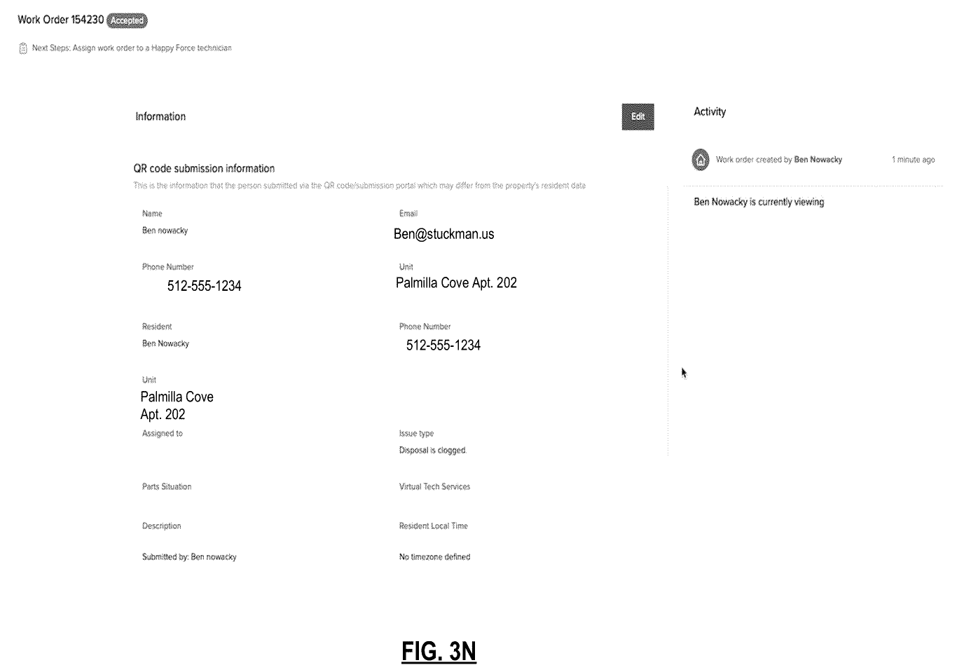

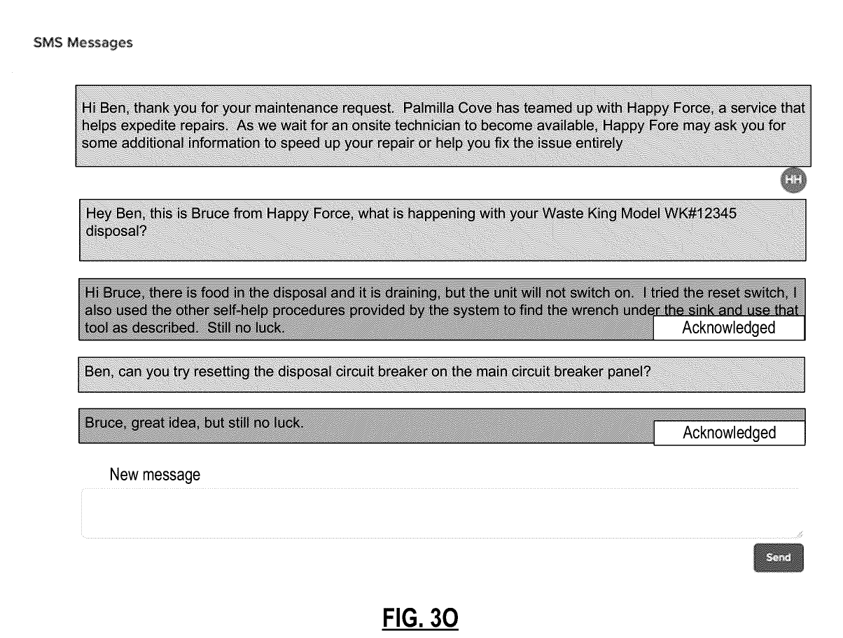

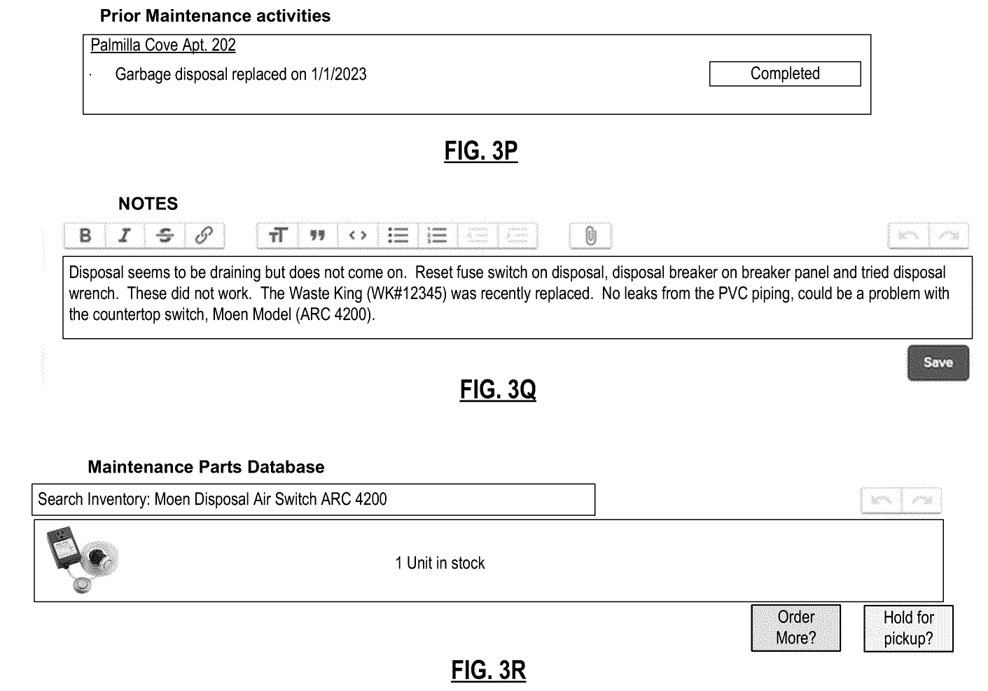

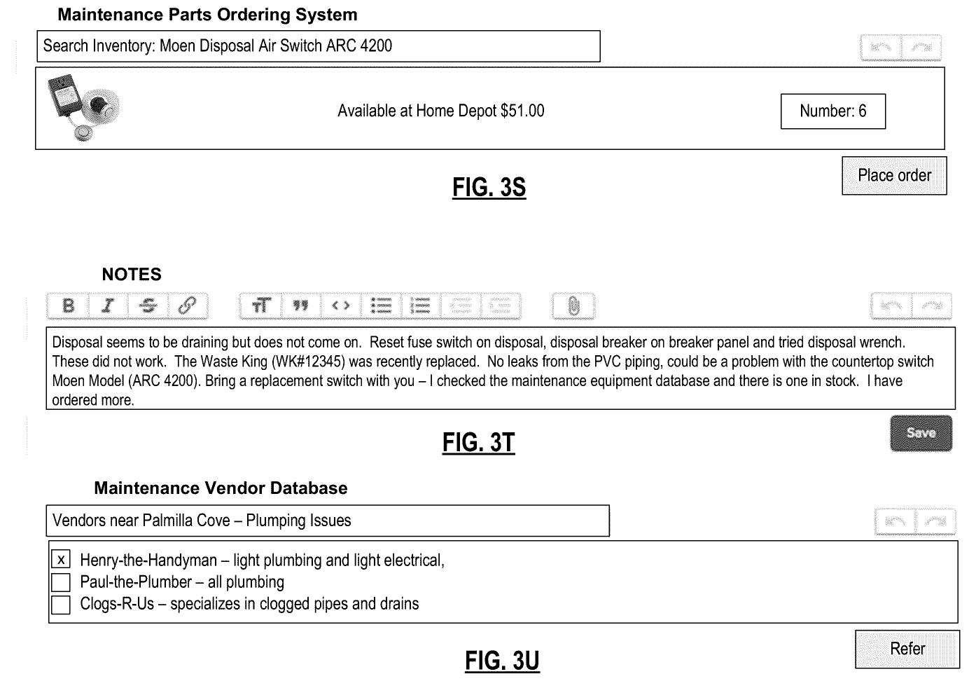

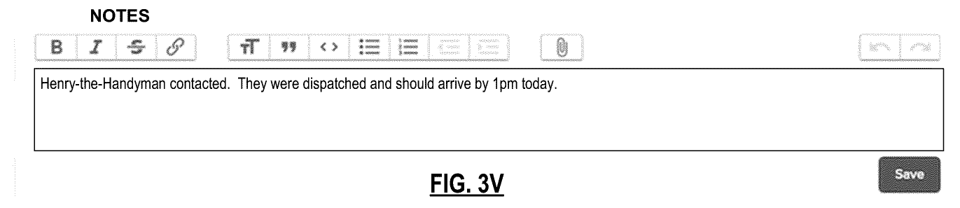

FIGS. 3A-3J present pictorial representation of portions of example screen displays of a client device. In particular, screen displays of a client device 20 associated with a resident of a particular unit of an apartment complex (e.g. Palmilla Cove, unit 202) are presented. These screen displays correspond to a graphical user interface (GUI) that can be implemented by a dedicated application, via a browser and/or via other software of the client device 20 in communication with the automated P/M platform 30 via network 50.

In FIG. 3A, the user of a client device 20 has accessed the GUI to begin to report a maintenance issue by entry of maintenance notification data. In FIG. 3B, the user has accessed a first menu that lists various issue categories and selected a plumbing issue. In FIG. 3C, the user the user has accessed a second menu that is a submenu for the plumbing category that lists various plumbing issues and selected a disposal issue. In FIG. 3D, the user the user has accessed a third menu that is a submenu for plumbing/disposal that lists various disposal issues and proceeds to select that the disposal is clogged. In FIG. 3E, the GUI indicates the particular maintenance notification data that has been collected. In FIGS. 3F and 3G, the user interacts with the GUI to enter a property identifier that indicates the specific property unit, (in this example Palmilla Cove, Unit 202) as well as other information regarding the user including contact information.

This information is submitted to the automated P/M platform 30 via the network 50. The automated P/M platform 30 responds by automatically determining, based on the maintenance notification data, specific premises equipment at the specific property unit. In particular, the automated P/M platform 30 stores a property equipment database 30-2 that correlates instances of premises equipment (e.g., the make of model of each type of equipment to each property unit of all the properties under management. In this case, the automated P/M platform 30 determines that the particular disposal at Palmilla Cove, Unit 202 is a Waste King Disposal (#WK12345). As discussed, the automated P/M platform 30 also stores an equipment repair database 30-3 that correlates maintenance self-help data to the instances of premises equipment and also to corresponding ones of the plurality of maintenance issue types. In this case, it retrieves maintenance self-help data corresponding to self-help procedures specific to a clogged Waste King Disposal (#WK12345). This maintenance self-help data is then sent, via the network interface 50, client devices 20 for display via the graphical user interface as shown in FIGS. 3H and 3I.

As shown in FIG. 31, the user can click on buttons indicating that either the issue is fixed or that they still need help—indicating whether or not the issue has been resolved in response to following the self-help procedures. In the example shown, the user has indicated that the issue has not been resolved, and this maintenance self-help results data is sent to the automated P/M platform 30 via the network 50 in order to facilitate the corresponding maintenance request. An indication of the submission is presented via the GUI as shown in FIG. 3J.

FIGS. 3K-3V present pictorial representation of portions of example screen displays of a client device. In particular, screen displays of a client device 25 associated with a maintenance person are presented. These screen displays correspond to a graphical user interface (GUI) that can be implemented by a dedicated application, via a browser and/or via other software of the client device 25 in communication with the automated P/M platform 30 via network 50 and, for example, via the maintenance portal 30-1.

In FIG. 3K, the maintenance person has accessed the maintenance portal 30-1. In FIG. 3L, the maintenance person has used the maintenance portal 30-1 to access the maintenance request queue 30-4 and sees the maintenance submission for the clogged disposal has been queued. It should be noted that, in various examples, the maintenance submission reflected in the maintenance request queue 30-4 can be received as shown via the trouble ticket deflection process of FIGS. 3A-3J, but and also through other sources such as property systems 40. Maintenance personnel can then treat and triage these submissions and whenever possible, attempt (or further attempt) to resolve these issues without the need of an onsite repair visit.

The maintenance person is given the option to accept this submission and begin to address it, to start a work order directly or to delegate this submission to a property system 40 to handle this themselves. At this point the submission can be moved from the maintenance request queue 30-4 to the maintenance queue 30-5—in the example wherein these two queues are implemented separately. In FIG. 3M, the maintenance person has opted to accept the submission and will attempt to see if can be resolved via communications with the resident-thereby avoiding an onsite visit if possible. In FIG. 3N, the maintenance person has received further information regarding the submission. It should be noted that the maintenance person can, at any time, access the property equipment database 30-2 and equipment repair database 30-3 to, for example, determine the make and model of the disposal at Palmilla Cove unit 202 and also the particular self-help procedures that are specific to the type of issue that was reported.

In FIG. 3O, the maintenance person has engaged in anonymized communications with the resident via anonymized communication system 30-6 that, for example, identifies the origin of the communications to the operator of the automated P/M platform 30, as opposed to the specific client device 25 in use. In this fashion, different maintenance personal can seamlessly address a single request and furthermore, the resident is not given access to an email address, phone number or other identifier associated with any particular client device 25 or maintenance person. Reciprocally, the maintenance personnel may be blocked from access to an email address, phone number or other identifier associated with any particular client device 20 or user.

In the example shown, the communications attempt to either resolve the issue or narrow it down to simply the work of repair personnel, identify appropriate skills required by repair personnel for the particular issue, and determine which parts/equipment that may be necessary to the repair and/or whether these parts/equipment are available. While the communications shown are SMS messages, in other examples the communications can include emails, voice calls, video calls, videos and/or other communications media.

The first communication to the resident can be autogenerated. Furthermore, other communications can be autogenerated via generative AI or other systems. As communications are generated, they are stored in a communications records database 30-11 and can be accessed, for example, by other maintenance personnel via the maintenance portal 30-1 in order to further facilitate processing of the submission and/or can be indexed for access in conjunction with future submissions regarding that property or similar issues experienced by other properties. Furthermore, as each new communication from the resident is received, the maintenance person can acknowledge to the system that it was read. These acknowledgements can also be stored in the communications records database 30-11.

In the example shown in FIG. 3O, the maintenance person has narrowed down the problem via communications with the resident. In FIG. 3P, the maintenance person has accessed the maintenance history database 30-7 and determined that the disposal in the unit was recently replaced. This leads the maintenance person to believe the underlying problem probably lies with a countertop switch, determined from the property equipment database 30-2, to be a Moen Model ARC 4200. In FIG. 3Q, the maintenance person makes notes as to the results of his/her work that can be stored in association with the maintenance request and forwarded to repair personnel that will engage in a repair visit.

In FIG. 3R, the maintenance person accesses the maintenance parts database 30-8 and determines that the necessary part is in stock. And is given the option to hold the part for pick-up by the repair personnel and/or to order more. In FIG. 3S, the maintenance person accesses the maintenance parts ordering system 30-9 which automatically determines a source of the particular part and which facilitates placement of an order. In FIG. 3T, the notes have been updated and can be stored in association with the maintenance request and forwarded to repair personnel that will engage in a repair visit. The communications history and/or other submission information can be forwarded as well, such as photos or other information that was collected. In FIG. 3U, the maintenance person accesses the maintenance vendor database 30-10 which automatically displays a set of vendors related to the maintenance issue and in the locale. The maintenance person selects a particular vendor that suits the diagnosis of the source of the issue and refers the issue. In various examples, the maintenance vendor database 30-10 interacts with the maintenance portal to proactively schedule/dispatch a maintenance visit with the selected vendor and the notes can be updated as shown in FIG. 3V.

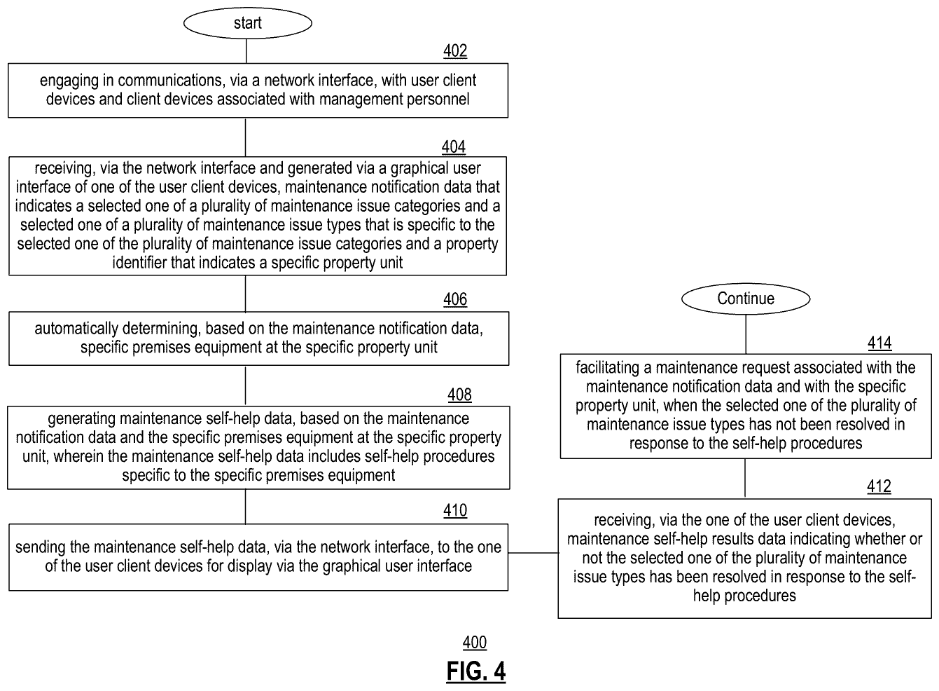

FIG. 4 presents a flowchart representation of an example method. In particular a method 400 is presented for use in conjunction with an automated P/M processing system 10 and/or in conjunction with any of the other functions/features described herein. Step 402 includes engaging in communications, via a network interface, with user client devices and client devices associated with management personnel. Step 404 includes receiving, via the network interface and generated via a graphical user interface of one of the user client devices, maintenance notification data that indicates a selected one of a plurality of maintenance issue categories and a selected one of a plurality of maintenance issue types that is specific to the selected one of the plurality of maintenance issue categories and a property identifier that indicates a specific property unit. Step 406 includes automatically determining, based on the maintenance notification data, specific premises equipment at the specific property unit. Step 408 includes generating maintenance self-help data, based on the maintenance notification data and the specific premises equipment at the specific property unit, wherein the maintenance self-help data includes self-help procedures specific to the specific premises equipment.

Step 410 includes sending the maintenance self-help data, via the network interface, to the one of the user client devices for display via the graphical user interface. Step 412 includes receiving, via the one of the user client devices, maintenance self-help results data indicating whether or not the selected one of the plurality of maintenance issue types has been resolved in response to the self-help procedures. Step 414 includes facilitating a maintenance request associated with the maintenance notification data and with the specific property unit, when the selected one of the plurality of maintenance issue types has not been resolved in response to the self-help procedures.

In various examples and in addition or alternative to any of the foregoing, the method further includes storing a property equipment database that correlates instances of premises equipment to each property unit of a plurality of property units, wherein the method further includes storing an equipment repair database that correlates maintenance self-help data to the instances of premises equipment and also to corresponding ones of the plurality of maintenance issue types.

In various examples and in addition or alternative to any of the foregoing, facilitating the maintenance request includes facilitating communications between maintenance personnel and a user of the client device regarding the maintenance request via an anonymized communication system utilizing one of the client devices associated with management personnel.

In various examples and in addition or alternative to any of the foregoing, facilitating the maintenance request includes providing the maintenance personnel access to the maintenance request via a maintenance portal utilizing one of the client devices associated with management personnel.

In various examples and in addition or alternative to any of the foregoing, the method further includes storing a communication records database, and wherein facilitating the maintenance request includes storing the communications between maintenance personnel and the user of the client device regarding the maintenance request in the communication records database, and wherein the communications between maintenance personnel and the user of the client device regarding the maintenance request are accessible via the maintenance personnel utilizing the maintenance portal.

In various examples and in addition or alternative to any of the foregoing, wherein the communications between the maintenance personnel and the user of the client device regarding the maintenance request are accessible via the maintenance personnel utilizing the maintenance portal in conjunction with a subsequent maintenance request associated with the specific property unit.

In various examples and in addition or alternative to any of the foregoing, facilitating the maintenance request includes queuing the maintenance request in a maintenance request queue that is accessible via the maintenance personnel utilizing the maintenance portal.

In various examples and in addition or alternative to any of the foregoing, facilitating the maintenance request includes forwarding, in response to maintenance personnel interaction with the maintenance portal, the maintenance request, the communications between the maintenance personnel and the user of the client device regarding the maintenance request, and notes of the maintenance personnel, to at least one of: a maintenance vendor, property management personnel associated with the specific property unit, or other maintenance personnel that are in proximity to the specific property unit and shifting the maintenance from the maintenance request queue to a separate maintenance queue.

In various examples and in addition or alternative to any of the foregoing, the method further includes storing a maintenance history database, and wherein facilitating the maintenance request includes storing records regarding the maintenance request in the maintenance history database, and wherein the records regarding the maintenance request are accessible utilizing one of the client devices associated with management personnel via a maintenance portal.

In various examples and in addition or alternative to any of the foregoing, the method further includes storing a maintenance parts database, and wherein facilitating the maintenance request includes storing records regarding maintenance parts inventory in the maintenance parts database, and wherein the records regarding the maintenance parts inventory are accessible utilizing one of the client devices associated with management personnel via a maintenance portal.

In various examples and in addition or alternative to any of the foregoing, the method further includes storing a maintenance vendor database, and wherein facilitating the maintenance request includes storing records regarding maintenance vendors in the maintenance vendor database, and wherein the records regarding the maintenance vendors are accessible utilizing one of the client devices associated with management personnel via a maintenance portal.

In various examples and in addition or alternative to any of the foregoing, facilitating the maintenance request includes providing maintenance personnel access to a maintenance parts ordering system utilizing one of the client devices associated with management personnel via a maintenance portal.

In various examples and in addition or alternative to any of the foregoing, the maintenance notification data further indicates a selected one of a plurality of maintenance issue subcategories that is specific to the selected one of a plurality of maintenance issue categories, wherein the selected one of a plurality of a maintenance issue types is further specific to the selected one of the plurality of maintenance issue subcategories, wherein the graphical user interface presents a first menu that presents the plurality of maintenance issue categories, a second menu of the maintenance issue subcategories and a third menu of plurality of a maintenance issue types, and wherein the maintenance notification data is generated in response to interaction with the first menu, the second menu and the third menu via a user of the client device.

In various embodiments, any set of the various examples listed above can be implemented in tandem, for example, in conjunction with performing some or all steps of FIG. 4, some or all steps of and/or any other function, feature and/or methodology described herein.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While transistors may be shown in one or more of the above-described figure(s) as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

As applicable, one or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition-requires “artificial” intelligence—i.e., machine/non-human intelligence.

As applicable, one or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

As applicable, one or more functions associated with the methods and/or processes described herein can be implemented in a system that is operable to electronically store digital data in a memory device. Such storage cannot practically be performed by the human mind because the human mind is not equipped to electronically store digital data.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A property management platform comprising:
a network interface configured to engage in communications with user client devices and client devices associated with management personnel;
at least one processor coupled to the network interface; and
a memory that stores executable instructions that, when executed by the at least one processor, cause the client device to:
receive, via the network interface and generated via a graphical user interface of one of the user client devices, maintenance notification data that indicates a selected one of a plurality of maintenance issue categories and a selected one of a plurality of maintenance issue types that is specific to the selected one of the plurality of maintenance issue categories and a property identifier that indicates a specific property unit;
automatically determine, based on the maintenance notification data, specific premises equipment at the specific property unit;
generate maintenance self-help data, based on the maintenance notification data and the specific premises equipment at the specific property unit, wherein the maintenance self-help data includes self-help procedures specific to the specific premises equipment;
send the maintenance self-help data, via the network interface, to the one of the user client devices for display via the graphical user interface;
receive, via the one of the user client devices, maintenance self-help results data indicating whether or not the selected one of the plurality of maintenance issue types has been resolved in response to the self-help procedures; and
facilitating a maintenance request associated with the maintenance notification data and with the specific property unit, when the selected one of the plurality of maintenance issue types has not been resolved in response to the self-help procedures.

2. The property management platform of claim 1, wherein the memory further stores a property equipment database that correlates instances of premises equipment to each property unit of a plurality of property units, wherein the memory that stores an equipment repair database that correlates maintenance self-help data to the instances of premises equipment and also to corresponding ones of the plurality of maintenance issue types.

3. The property management platform of claim 1, wherein facilitating the maintenance request includes facilitating communications between maintenance personnel and a user of the client device regarding the maintenance request via an anonymized communication system utilizing one of the client devices associated with management personnel.

4. The property management platform of claim 3, wherein facilitating the maintenance request includes providing the maintenance personnel access to the maintenance request via a maintenance portal utilizing one of the client devices associated with management personnel.

5. The property management platform of claim 4, wherein the memory further stores a communication records database, and wherein facilitating the maintenance request includes storing the communications between maintenance personnel and the user of the client device regarding the maintenance request in the communication records database, and wherein the communications between maintenance personnel and the user of the client device regarding the maintenance request are accessible via the maintenance personnel utilizing the maintenance portal.

6. The property management platform of claim 5, wherein the communications between the maintenance personnel and the user of the client device regarding the maintenance request are accessible via the maintenance personnel utilizing the maintenance portal in conjunction with a subsequent maintenance request associated with the specific property unit.

7. The property management platform of claim 5, wherein facilitating the maintenance request includes queuing the maintenance request in a maintenance request queue that is accessible via the maintenance personnel utilizing the maintenance portal.

8. The property management platform of claim 7, wherein facilitating the maintenance request includes forwarding, in response to maintenance personnel interaction with the maintenance portal, the maintenance request, the communications between the maintenance personnel and the user of the client device regarding the maintenance request, and notes of the maintenance personnel, to at least one of: a maintenance vendor, property management personnel associated with the specific property unit, or other maintenance personnel that are in proximity to the specific property unit and shifting the maintenance from the maintenance request queue to a separate maintenance queue.

9. The property management platform of claim 1, wherein the memory further stores a maintenance history database, and wherein facilitating the maintenance request includes storing records regarding the maintenance request in the maintenance history database, and wherein the records regarding the maintenance request are accessible utilizing one of the client devices associated with management personnel via a maintenance portal.

10. The property management platform of claim 1, wherein the memory further stores a maintenance parts database, and wherein facilitating the maintenance request includes storing records regarding maintenance parts inventory in the maintenance parts database, and wherein the records regarding the maintenance parts inventory are accessible utilizing one of the client devices associated with management personnel via a maintenance portal.

11. The property management platform of claim 1, wherein the memory further stores a maintenance vendor database, and wherein facilitating the maintenance request includes storing records regarding maintenance vendors in the maintenance vendor database, and wherein the records regarding the maintenance vendors are accessible utilizing one of the client devices associated with management personnel via a maintenance portal.

12. The property management platform of claim 1, wherein facilitating the maintenance request includes providing maintenance personnel access to a maintenance parts ordering system utilizing one of the client devices associated with management personnel via a maintenance portal.

13. The property management platform of claim 1, wherein the maintenance notification data further indicates a selected one of a plurality of maintenance issue subcategories that is specific to the selected one of a plurality of maintenance issue categories, wherein the selected one of a plurality of a maintenance issue types is further specific to the selected one of the plurality of maintenance issue subcategories, wherein the graphical user interface presents a first menu that presents the plurality of maintenance issue categories, a second menu of the maintenance issue subcategories and a third menu of plurality of a maintenance issue types, and wherein the maintenance notification data is generated in response to interaction with the first menu, the second menu and the third menu via a user of the client device.

14. A client device for use with a property management platform, the client device comprising:
a network interface configured to engage in communications with the property management platform;
a display device configured to implement a graphical user interface;
at least one processor coupled to the network interface and the display device; and
a memory that stores executable instructions that, when executed by the at least one processor, cause the client device to:
generate, via the graphical user interface, maintenance notification data that indicates a selected one of a plurality of maintenance issue categories and a selected one of a plurality of maintenance issue types that is specific to the selected one of the plurality of maintenance issue categories;
send to the property management platform, via the network interface, the maintenance notification data and a property identifier that indicates a specific property unit;
receive from the property management platform, via the network interface, maintenance self-help data that includes self-help procedures generated based on the selected one of the plurality of maintenance issue categories and the selected one of the plurality of maintenance issue types, and is further based on automatic determination, via the property management platform, of specific premises equipment at the specific property unit and wherein the maintenance self-help data is specific to the specific premises equipment at the specific property unit;
display the maintenance self-help data via the graphical user interface to facilitate the self-help procedures;
receive, via the graphical user interface, maintenance self-help results data indicating whether or not the selected one of the plurality of maintenance issue types has been resolved in response to the self-help procedures; and
facilitate a maintenance request of the property management platform associated with the selected one of the plurality of maintenance issue types associated with the specific property unit, when the selected one of the plurality of maintenance issue types has not been resolved in response to the self-help procedures.

15. The client device of claim 14, wherein the property management platform includes a property equipment database that correlates instances of premises equipment to each property unit of a plurality of property units, wherein the property management platform further includes an equipment repair database that correlates maintenance self-help data to the instances of premises equipment and also to corresponding ones of the plurality of maintenance issue types.

16. The client device of claim 14, wherein the property management platform includes an anonymized communication system, and wherein facilitating the maintenance request includes facilitating communications between maintenance personnel and a user of the client device regarding the maintenance request via the anonymized communication system.

17. The client device of claim 16, wherein the property management platform includes a maintenance portal accessible by maintenance personnel, and wherein facilitating the maintenance request includes providing the maintenance personnel access to the maintenance request via the maintenance portal.

18. The client device of claim 17, wherein the property management platform includes a communication records database, and wherein facilitating the maintenance request includes storing the communications between maintenance personnel and the user of the client device regarding the maintenance request in the communication records database, and wherein the communications between maintenance personnel and the user of the client device regarding the maintenance request are accessible via the maintenance personnel utilizing the maintenance portal.

19. The client device of claim 18, wherein facilitating the maintenance request includes queuing the maintenance request in a maintenance request queue that is accessible via the maintenance personnel utilizing the maintenance portal.

20. The client device of claim 19, wherein facilitating the maintenance request includes forwarding, in response to maintenance personnel interaction with the maintenance portal, the maintenance request, the communications between the maintenance personnel and the user of the client device regarding the maintenance request, and notes of the maintenance personnel, to at least one of: a maintenance vendor, property management personnel associated with the specific property unit, or other maintenance personnel that are in proximity to the specific property unit and shifting the maintenance from the maintenance request queue to a separate maintenance queue.
